(19) United States
(12) Patent Application Publication
(10) Pub. No.: US 2003/0210467 A1
(43) Pub. Date: Nov. 13, 2003

(54) Wearable color display system

(75) Inventor: Young-Ran Song, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/402,132

(22) Filed: Mar. 31, 2003

(30) Foreign Application Priority Data
May 13, 2002 (KR) 2002-26159

(51) Int. Cl. G02B 27/14

(52) U.S. Cl. 359/630

(57) ABSTRACT

A wearable color display system includes a grating, a waveguide, and an ocular lens. The grating receives red (R), greed (G), and blue (B) color components of image signals and respectively refracts the image signals at predetermined angles in regard to the R, G, and B color components of the image signals. The waveguide transmits the R, G, and B color components of the R, G, and B image signals refracted via the grating. The ocular lens outputs the R, G, and B color components of the R, G, and B image signals transmitted via the waveguide to a substantially identical focus.

### CROSS-REFERENCE TO RELATED APPLICATIONS

This application claims the priority of Korean Patent Application No. 2002-26159, filed on May 13, 2002, in the Korean Intellectual Property Office, the disclosure of which is incorporated herein in its entirety by reference.

### BACKGROUND OF THE INVENTION

1. Field of the Invention

The present invention relates to a wearable display system, and more particularly, to a wearable color display system for displaying color images in response to color signals.

2. Description of the Related Art

A wearable display system generally known as a head or helmet mounted display (HMD) system is increasingly used as an optical display system for military, medical, or personal display applications. Such HMD system includes a wearable device like glasses, goggles, or a helmet via which a user can watch image signals. It is one of the advantages of the wearable HMD system that the user can receive image information even when the user is moving.

FIG. 1 shows a conventional HMD system. As shown in FIG. 1, the HMD system generally includes glass lenses 100 and an image-producing unit 110 provided at a center of the glass lenses 100. As can be seen in FIG. 1, the image-producing unit 100 is outstandingly bulky and heavy, and it does not look good when considering an overall appearance of the HMD system. Such bulky and heavy structure of the image-producing unit 110 is mainly due to numerous optical devices incorporated therein.

FIG. 2 is a block diagram showing the structure of the conventional HMD system. As shown in FIG. 2, the HMD system includes an image-producing unit 200, a display panel 210, and an optical system 220. The image-producing unit 200 receives and stores the image signals provided from an external source such as a personal computer or a video player (not shown), and processes the received image signals to display an image on the display panel 210, such as an LCD panel. The optical system 220 magnifies, via a magnifying optics system, the image displayed on the display panel 210 to produce a virtual image that is shown to a user's eyes in an adequately magnified size. Meanwhile, the HMD system may additionally include peripheral devices, such as a support member allowing the user to wear the HMD system, or a wire for receiving the image or other signals from the external sources.

FIG. 3 shows a structure of a conventional optical system incorporated in the conventional HMD system shown in FIG. 2. As shown in FIG. 3, the conventional optical system includes a collimating lens 300, an X-prism 310, left and right focusing lenses 320, reflecting mirrors 330, and ocular or magnifying lenses 340. The collimating lens 300 transduces light, i.e., an image signal, emitted from a source of light such as the display panel 210 into a beam of light, i.e., a parallel light, and transmits the light beam to the X-prism 310. The X-prism 310 divides the light beam transmitted from the collimating lens 300 into two spectral beams directed leftward and rightward, respectively, and transmits the two spectral beams to the left and right focusing lenses 320, placed with respect to the X-prism 310. The focusing lenses 320 focus the spectral beams, and the reflecting mirrors 330 redirect the focused beams. The redirected beams progress toward the user's eyes through the ocular or magnifying lenses 340. The ocular lenses 340 magnify the image signal that has been emitted from the display panel and passed through the above-described optical devices so that magnified images are ultimately shown to the user's eyes. In the event that the image signal is a color signal, such type of lenses that can remove chromatic aberration should be used as the ocular lenses 340.

As described above, the conventional optical system of the conventional wearable display system, such as the HMD, incorporates numerous optical devices, such as the collimating lens 300, the X-prism 310, the focusing lens 320, the reflecting mirrors 330, and the ocular lenses 340, all requiring high precision. In view of characteristics of the optical devices requiring high precision, it is extremely hard to embody the optical devices in an optical system, and a lot of time and endeavor is needed to fabricate the optical system. Even though the individual optical devices are precisely designed, there is a difficulty to precisely assemble the optical devices with each other. Further, as already mentioned with reference to FIG. 1, the conventional optical system or the image-producing unit incorporating the optical system is considerably bulky and heavy because of the numerous optical devices. Therefore, it is inconvenient for the user to wear the HMD system. Moreover, production cost of the HMD system increases due to the numerous optical devices and the difficulties in fabricating the optical system.

Meanwhile, the wearable display system that is capable of displaying the color images has not been yet commercialized. However, it is expected that demands on such wearable display system capable of displaying color images would increase, and accordingly, a necessity for developing a wearable color display system arises.

### SUMMARY OF THE INVENTION

In accordance with an aspect of the present invention, there is provided a wearable color display system that has a simple structure and is capable of displaying color images with less optical devices.

A wearable color display system, according to an aspect of the present invention, includes a grating receiving red (R), green (G), and blue (B) color components of image signals and respectively refracting the image signals at predetermined angles in regard to the R, G, and B color components of the image signals; a waveguide transmitting the R, G, and B color components of the R, G, and B image signals refracted via the grating; and an ocular lens outputting the R, G, and B color components of the image signals transmitted via the waveguide to a substantially identical focus.

In the wearable color display system, according to an aspect of the present invention, the grating is a multiplexing type grating in which the R, G, and B color components of the image signals are refracted via a same grating at predetermined angles.

In the wearable color display system, according to an aspect of the present invention, the grating is a lamination type grating in which a layer that refracts only one signal among the R, G, and B color components of the image signals at a predetermined angle is laminated on another layer that refracts only another signal at another predetermined angle.

In the wearable color display system, according to an aspect of the present invention, the ocular lens is a multiplexing type lens in which the R, G, and B color components of the image signals are converged to the substantially identical focus via a same lens.

In the wearable color display system, according to an aspect of the present invention, the ocular lens is a lamination type lens in which a layer that refracts and outputs only one signal among the R, G, and B color components of the image signals at a predetermined angle is laminated on another layer that refracts and outputs only another signal at another predetermined angle, and the R, G, and B color components of the image signals refracted via the respective layers are converged to the substantially identical focus.

In the wearable color display system, according to an aspect of the present invention, the system additionally includes a display panel; a lighting unit producing the R, G, and B color components of the image signals; and a color image-producing producing an image to be displayed and comprising the display panel to output color image signals in response to the R, G, and B color components of the image signals from the lighting unit.

In the wearable color display system, according to an aspect of the present invention, the light emitting diodes operate as light sources of the R, G, and B color components of the image signals, a filter sharpens wavelengths of the respective R, G, and B color components of the image signals, and a collimating lens transmits the R, G, and B color components of the image signals passed through the filter parallel with each other.

In the wearable color display system, according to an aspect of the present invention, the display panel is a liquid crystal display (LCD) panel, and the lighting unit includes a white luminescent diode serving as a backlight of the LCD panel, and filters filtering and sharpening wavelengths of the R, G, and B color components of the image signal emitted from the white luminescent diode, wherein the filters correspond to a number of pixels of the LCD panel.

In the wearable color display system, according to an aspect of the present invention, the display panel is a liquid crystal display (LCD) panel, and the lighting unit provides the R, G, and B color components of the image signals via optical fibers.

In the wearable color display system, according to an aspect of the present invention, the lighting unit includes a beam expander expanding beam sizes of the R, G, and B color components of the image signals having small beam sizes, and outputting the R, G, and B color components of the image signals in expanded beam sizes.

These together with other aspects and advantages which will be subsequently apparent, reside in the details of construction and operation as more fully hereinafter described and claimed, reference being had to the accompanying drawings forming a part thereof, wherein like numerals refer to like parts throughout.

### BRIEF DESCRIPTION OF THE DRAWINGS

These and/or other objects and advantages of the invention will become apparent and more readily appreciated from the following description of the embodiments, taken in conjunction with the accompanying drawings of which:

FIG. 1 shows a conventional HMD system;

FIG. 2 is a block diagram showing a structure of the conventional HMD system;

FIG. 3 shows a structure of a conventional optical system incorporated in the conventional HMD system shown in FIG. 2;

FIG. 4 shows a structure of a wearable color display system, according to an aspect of the present invention;

FIG. 5 shows an example of a lamination type grating;

FIG. 6(a) shows an arrangement of an LED;

FIG. 6(b) shows the LED combined with a filter in the lighting unit shown in FIG. 4;

FIG. 6(c) shows brightness of R, G, and B color components of the LED versus a wavelength;

FIG. 6(d) shows a transmissivity of the LED versus wavelength;

FIGS. 7(a)-7(c) show examples of the lighting unit shown in FIG. 4; and

FIG. 8 shows another aspect of the wearable color display system, according to the present invention.

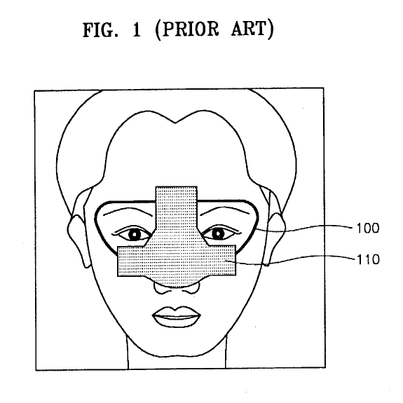

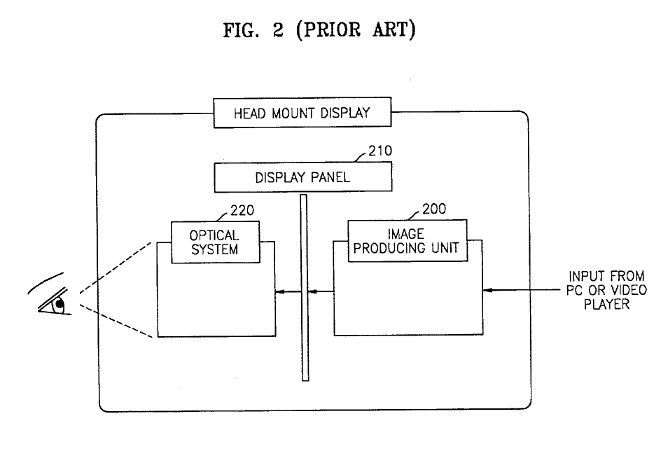

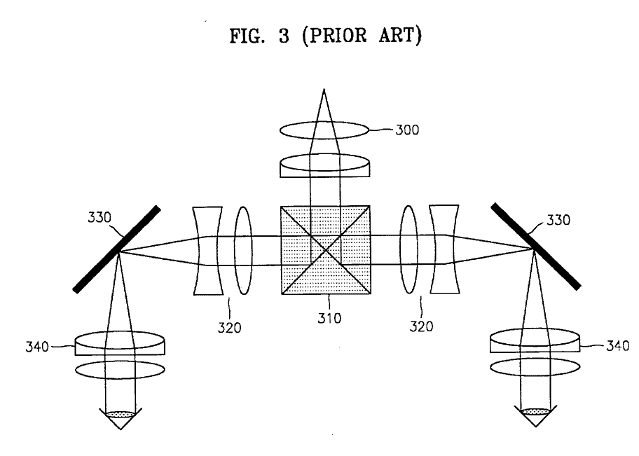

### DETAILED DESCRIPTION OF THE INVENTION

Reference will now be made in detail to the embodiments of the present invention, examples of which are illustrated in the accompanying drawings, wherein like reference numerals refer to like elements throughout. The embodiments are described below in order to explain the present invention by referring to the figures.

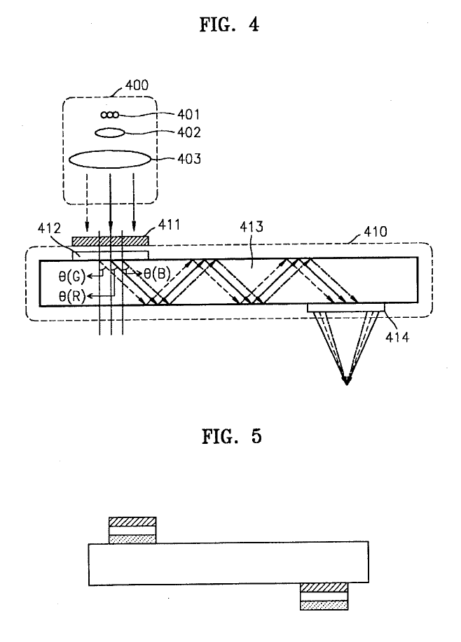

A wearable color display system, according to an aspect of the present invention includes a lighting unit 400 and an ocular lens system 410, as shown in FIG. 4.

The lighting unit 400 produces beams of light with the combination of three basic color components, i.e., red (R), green (G), and blue (B) color components, as a backlight. In accordance with an aspect of the present invention, the lighting unit 400 includes light emitting diodes (LEDs) 401 that emit the beams of light with wavelengths corresponding to the R, G, and B color components, respectively, an interference filter 402 which filters relatively large wavelengths of the R, G, and B color components emitted from the respective LEDs to very small wavelengths, and a collimating lens 403 which outputs the filtered beams of light parallel with each other.

The ocular lens system 410 can be incorporated in a light and small sized wearable device to show color image signals to a user. The ocular lens system 410 includes a display panel 411, a grating 412, a waveguide 413, and an ocular lens 414.

The display panel 411 outputs the color image signals with the combination of the R, G, and B color components in response to the light beams from the lighting unit 400. The display panel 411 is not necessarily incorporated in the ocular lens system 410.

The grating 412 refracts the color image signals from the display panel 411 at predetermined angles. Because the color image signals have the combination of the R, G, and B color components; the grating 412 may provide respective predetermined refraction angles θ(λ) according to the wavelengths λ of the R, G, and B color components. The refraction angles θ(λ) are calculated such that the R, G, and B color components are totally refracted by the waveguide, and are moved by identical distances in the waveguide. According to an aspect of the present invention shown in FIG. 4, the grating 412 is a multiplexing type grating having patterns that respectively correspond to the wavelengths of the R, G, and B color components formed in one grating so that the color image signals of three wavelengths, each corresponding to the R, G, and B color components, can be diffracted at respective angles via one grating.

The waveguide 413 serves as a signal transmission medium, which transmits the image signals passed through the grating 412 in a predetermined direction.

The ocular lens 414, which is attached on a surface of the waveguide 413, outputs the color image signals transmitted via the waveguide 412. The ocular lens 414 is in a conjugate relationship with the grating 412. That is, if the grating 412 diffracts an input signal with a predetermined incidence angle at a predetermined refraction angle, the ocular lens 414 receives the input signal transmitted with the predetermined refraction angle of the grating 412, and refracts and outputs the signal at an angle identical to a predetermined incidence angle to the grating 412. The ocular lens 414 converges the R, G, and B color components at an identical focusing distance after passing through the ocular lens 414. As mentioned above, the display panel 411 is an optional device for the ocular lens system 410, and is not necessarily incorporated in the ocular lens system 410. That is, the image signals can be provided from external sources other than the display panel to the ocular lens system 410.

FIG. 5 shows a lamination type grating, which is a different type from the multiplexing type grating shown in FIG. 4. The lamination type grating has laminated layers that respectively refract a color component of only one wavelength at a predetermined angle in regard to the R, G, and B color components, and transmit the other signals without refraction. FIG. 5 also shows a lamination type ocular lens having the same function as the lamination type grating. The R, G, and B color components of the image signals passed through the layers are converged to an identical focus.

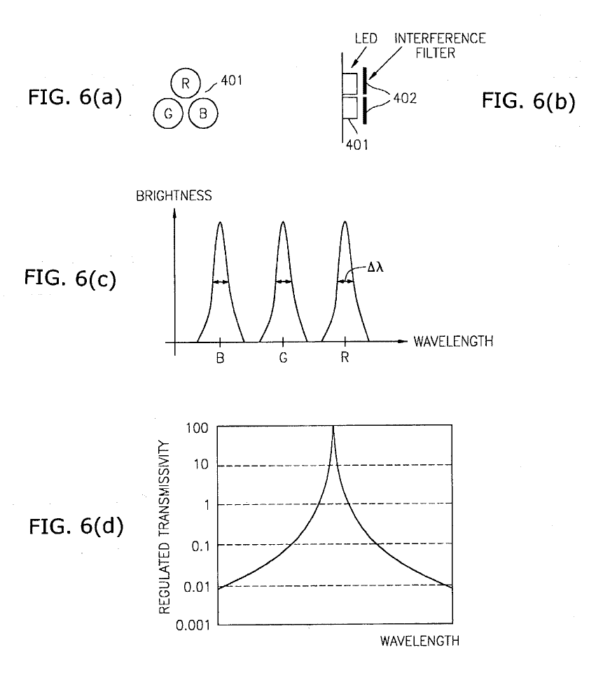

FIG. 6(a) shows an example for a placement of three basic color components of light, i.e., R, G, and B color components. FIG. 6(b) shows an example for the placement of the LEDs 401 and the filters 402. The filters 402 can be placed in correspondence with the LEDs 401 producing the R, G, and B color components, respectively. The LEDs 401 for producing the R, G, and B color components, respectively, produce rays of light having wavelengths Δλ of a few tens of nanometers. Such large wavelengths may be reduced to predetermined wavelengths suitable for a grating that is fabricated to refract the predetermined wavelengths at predetermined angles. Accordingly, the interference filters 402, which respectively pass the R, G, and B color components having center wavelengths, may be placed adjacent to the LEDs 401. FIG. 6(c) shows spectrum bands of the LEDs that respectively produce the R, G, and B color components. FIG. 6(d) shows an example of a spectrum obtained using the filter 402.

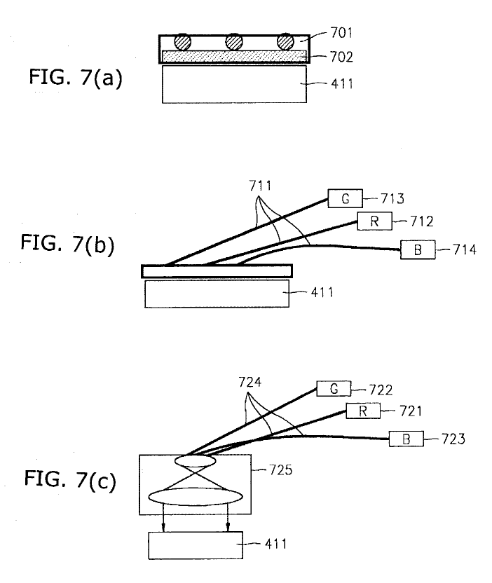

FIGS. 7(a)-7(c) show examples of the lighting unit shown in FIG. 4. FIG. 7(a) shows a backlight unit that can be used as the lighting unit when the display panel 411 is an LCD panel. The backlight unit includes a white luminescent diode 701, which produces a white ray of light, and a filter 702, which filters and sharpens the wavelengths of the R, G, and B color components in the white ray of light from the white luminescent diode 701. The filter 702 may correspond to the respective pixels of the LCD panel.

FIG. 7(b) shows another example of the lighting unit that can be used when the display panel 411 is the LCD panel. The lighting unit shown in FIG. 7(b) provides the R, G, and B color components of lights 712, 713, and 714 via optical fibers 711. Because the R, G, and B color components of the lights 712, 713, and 714 provided via the optical fibers are signals having substantially short wavelengths, a filter is not separately needed.

FIG. 7(c) shows still another example of the lighting unit that can be used when the display panel 411 is the LCD panel. The lighting unit shown in FIG. 7(c) includes a beam expander 725 to expand beams sizes of the R, G, and B color components of lights 721, 722, and 723 having small beam sizes so as to pass through the optical fibers 724, and to provide the expanded beams to the display panel 411.

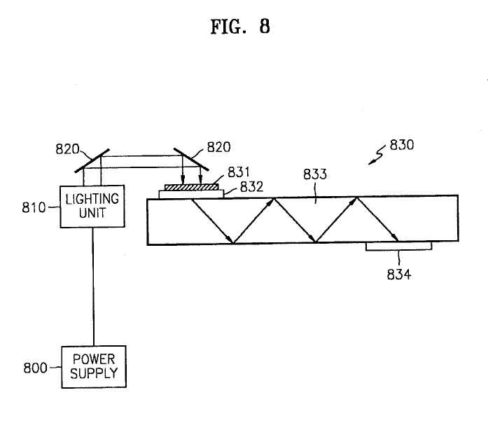

FIG. 8 shows another embodiment of a wearable color display system, according to an aspect of the present invention. The system shown in FIG. 8 includes a power supply 800, a lighting unit 810, reflecting mirrors 820, and an ocular lens system 830.

The power supply 800 provides power to the lighting unit 810. The lighting unit 810 includes an element for producing light, such as an LED, a laser, an LD, etc., and produces R, G, and B color luminescent lights. The reflecting mirrors 820 are supportive elements to adjust directions of the R, G, and B luminescent lights while the user is wearing the system as if wearing glasses.

The ocular lens system 830 can be attached to or incorporated in the light and small sized wearable device to show the color image signals to the user. The ocular lens system 830 includes a display panel 831, a grating 832, a waveguide 833, and an ocular lens 834.

The display panel 831 is an image display device, which outputs the color image signals with the combination of the R, G, and B color components in response to the light beams from the lighting unit 810.

The grating 832 refracts the color image signals from the display panel 831 at predetermined angles. Because the color image signals have the combination of the R, G, and B color components; the grating 832 may respectively provide predetermined refraction angles θ(λ) according to the wavelengths λ of the respective R, G, and B color components. The refraction angles θ(λ) are calculated such that the R, G, and B color components are totally refracted by the waveguide and are moved by identical distances in the waveguide 833. The grating 832 may be the multiplexing type grating having patterns that respectively correspond to the wavelengths of the R, G, and B color components formed in one grating, so that the signals of the three wavelengths can be diffracted at respective angles via one grating. In the alternative, the grating 832 may be the lamination type grating that has laminated layers that respectively refract the signal component of only one wavelength at a predetermined angle in regard to the R, G, and B signal components, and transmit the other signals without refraction.

The waveguide 833 serves as a signal transmission medium, which transmits image signals passed through the grating 832 in a predetermined direction. The ocular lens 834, which is attached on a surface of the waveguide 833, outputs the color image signals transmitted via the waveguide 832. The ocular lens 834 is in a conjugate relationship with the grating 832. That is, if the grating 832 diffracts the input signal with a predetermined incidence angle at a predetermined refraction angle, the ocular lens 834 receives the signal transmitted with the predetermined refraction angle of the grating 832, and refracts and outputs the signal at an angle identical to the predetermined incidence angle to the grating 832. The ocular lens 834 converges the R, G, and B color components at an identical focusing distance after passing through the ocular lens 834. The ocular lens 834 may be either a multiplexing type or a laminations type lens.

A wearable color display system, according to an aspect of the present invention, is capable of displaying color images with less optical devices and with a simple construction, and a user can conveniently wear the system to see color images.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A wearable color display system, comprising:
a grating receiving red (R), green (G), and blue (B) color components of image signals and respectively refracting the image signals at predetermined angles in regard to the R, G, and B color components of the image signals;
a waveguide transmitting the R, G, and B color components of the image signals refracted via the grating; and
an ocular lens outputting the R, G, and B color components of the R, G, and B image signals transmitted via the waveguide to a substantially identical focus.

2. The wearable color display system according to claim 1, wherein the grating is a multiplexing type grating in which the R, G, and B color components of the image signals are refracted via a same grating at predetermined angles.

3. The wearable color display system according to claim 1, wherein the grating is a lamination type grating in which a layer that refracts only one signal among the R, G, and B color components of the image signals at a predetermined angle is laminated on another layer that refracts only another signal at another predetermined angle.

4. The wearable color display system according to claim 1, wherein the ocular lens is a multiplexing type lens in which the R, G, and B color components of the image signals are converged to the substantially identical focus via a same lens.

5. The wearable color display system according to claim 1, wherein the ocular lens is a lamination type lens in which a layer that refracts and outputs only one signal among the R, G, and B color components of the image signals at a predetermined angle is laminated on another layer that refracts and outputs only another signal at another predetermined angle, and the R, G, and B color components of the image signals refracted via the respective layers are converged to the substantially identical focus.

6. The wearable color display system according to claim 1, further comprising:
a display panel;
a lighting unit producing the R, G, and B color components of the image signals; and
a color image-producing producing an image to be displayed and comprising the display panel to output color image signals in response to the R, G, and B color components of the image signals from the lighting unit.

7. The wearable color display system according to claim 6, wherein the lighting unit comprises:
light emitting diodes operating as light sources of the R, G, and B color components of the image signals,
a filter that sharpens wavelengths of the respective R, G, and B color components of the image signals, and
a collimating lens that transmits the R, G, and B color components of the image signals passed through the filter parallel with each other.

8. The wearable color display system according to claim 6, wherein the display panel is a liquid crystal display (LCD) panel, and the lighting unit comprises:
a white luminescent diode serving as a backlight of the LCD panel, and
filters filtering and sharpening wavelengths of the R, G, and B color components of the image signal emitted from the white luminescent diode, wherein the filters correspond to a number of pixels of the LCD panel.

9. The wearable color display system according to claim 6, wherein the display panel is a liquid crystal display (LCD) panel, and the lighting unit provides the R, G, and B color components of the image signals via optical fibers.

10. The wearable color display system according to claim 6, wherein the lighting unit comprises:
a beam expander expanding beam sizes of the R, G, and B color components of the image signals having small beam sizes, and outputting the R, G, and B color components of the image signals in expanded beam sizes.
